(19) United States
(12) Patent Application Publication
(10) Pub. No.: US 2003/0008085 A1
(43) Pub. Date: Jan. 9, 2003

(54) Laundry product

(75) Inventors: Dorothee Helene Davenet, Geneve (CH); Gisbert Marin Spieles, Brussels (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/174,725

(22) Filed: Jun. 19, 2002

(30) Foreign Application Priority Data
Jun. 19, 2001 (GB) 0114910.3

(51) Int. Cl. B32B 1/02

(52) U.S. Cl. 428/35.4; 428/35.2

(57) ABSTRACT

The present invention relates to a laundry bag made of at least two types of material: (i) a first material that is water-insoluble; and (ii) a second material that is water-soluble and/or water-dispersible; the laundry bag contains a component selected from the group consisting of odor control agent, perfume, dye transfer inhibitor, and combinations thereof. The laundry bag is suitable for use in an automatic washing machine.

### CROSS REFERENCE TO RELATED APPLICATIONS

This application claims priority under 35 U.S.C. §119(a) to Great Britain Application Serial No. 0114910.3, filed Jun. 19, 2001 (Attorney Docket No. CM2584F).

### FIELD OF THE INVENTION

The present invention relates to a laundry bag. More particularly to a laundry bag for use in containing, storing and/or transporting soiled laundry prior to and/or during the washing process.

### BACKGROUND OF THE INVENTION

Current washing practices involve collecting, sorting out and dividing soiled laundry into more than one wash load, transporting a wash load to a washing machine and inserting the wash load into the washing machine. Detergents then need to be added to the washing machine. This practice can be time consuming and tiresome for the consumer. In addition, during this laundry washing practice, the consumer comes into close proximity to the soiled laundry and detergent ingredients, on numerous occasions. There is a need to improve this time consuming laundry washing practice, and to minimize the amount of contact that occurs between the consumer and the soiled laundry before and during the laundering process.

The present invention provides a laundry bag, which improves the efficiency of current washing processes, decreases the duration of typical laundry washing processes and minimizes the amount of contact between the consumer and the soiled laundry. The inventors have found that by using a laundry bag comprising at least two types of material: (i) a first material that is water-insoluble; and (ii) a second material that is water-soluble and/or water-dispersible, the above-mentioned problems are overcome. During the storage of colored articles in a laundry bag, dye transfer between these colored articles can occur. This problem is overcome by one preferred embodiment of the present invention wherein the laundry bag comprises a dye transfer inhibitor. Also, malodor may occur when soiled laundry is stored in a laundry bag. This problem is overcome by a preferred embodiment of the present invention wherein the laundry bag comprises an odor control agent and/or a perfume.

### SUMMARY OF THE INVENTION

In a first embodiment of the present invention, there is provided a laundry bag comprising at least two types of material: (i) a first material that is water-insoluble; and (ii) a second material that is water-soluble and/or water-dispersible; the laundry bag comprises a component selected from the group consisting of odor control agent, perfume, dye transfer inhibitor, and combinations thereof.

In a second embodiment of the present invention, there is provided a process of preparing a laundry bag comprising at least two types of material: (i) a first material that is water-insoluble; and (ii) a second material that is water-soluble and/or water-dispersible; the laundry bag comprises a component selected from the group consisting of odor control agent, perfume, dye transfer inhibitor, and combinations thereof, whereby the walls of the bag defined by the inner volume space, are provided by a first and/or second material and optionally additional materials.

In a third embodiment of the present invention, there is provided a combination of a detergent composition or part thereof and a laundry bag comprising at least two types of material: (i) a first material that is water-insoluble; and (ii) a second material that is water-soluble and/or water-dispersible; the laundry bag comprises a component selected from the group consisting of odor control agent, perfume, dye transfer inhibitor, and combinations thereof, to treat fabric.

### DETAILED DESCRIPTION OF THE INVENTION

Laundry Bag

The laundry bag, herein referred to as “bag”, is made of at least two types of material, a first material that is water-insoluble and a second material that is water-soluble and/or water-dispersible. The first material and the second material are described in more detail hereinafter.

The water-insoluble material typically has a water-solubility of less than 50%, preferably less than 25% or even less than 5%, as measured by the method set out hereinafter using a glass-filter with a maximum pore size of 20 microns, namely: Gravimetric method for determining water-solubility or water-dispensability of the material of the bag: 10 grams ±0.1 gram of material is added in a 400 ml beaker, whereof the weight has been determined, and 245 ml ±1 ml of deionised water is added. This is stirred vigorously on magnetic stirrer set at 600 rpm, for 30 minutes. Then, the mixture is filtered through a folded qualitative sintered-glass filter with the pore sizes as defined above (max. 20 or 50 micron). The water is dried off from the collected filtrate by any conventional method, and the weight of the remaining polymer is determined (which is the dissolved or dispersed fraction). Then, the % water-solubility or water-dispensability can be calculated.

The bag contains a component selected from the group consisting of odor control agent, perfume, dye transfer inhibitor and combinations thereof. The odor control agent, perfume and dye transfer inhibitor are described in more detail hereinafter. The laundry bag may contain a detergent composition or part thereof. The detergent composition is described in more detail hereinafter.

The laundry bag preferably comprises at least one dispensing unit. The dispensing unit typically stores and dispenses at least one component selected from the group consisting of odor control agent, perfume, dye transfer inhibitor and combinations thereof. The dispensing unit can also be used to store and dispense a detergent composition or part thereof, if present. The dispensing unit is described in more detail hereinafter.

The bag is of a size suitable to hold at least one item of laundry. The size of the bag is dependant on its application. For example, the inner volume of the bag defined by the bag walls can be large, for example of a size from 2 m³ or from 3 m³, to 6 m³ or to 7 m³, which can hold large washing loads, for example washing loads up to 20 kg, for example, for use by a family household, or even for use by a hotel or restaurant. The inner volume of the bag can also be small, for example of a size from 0.001 m³ or from 0.005 m³, or from 0.01 m³ or from 0.1 m³, to 2 m³ or to 3 m³ suitable for holding washing loads consisting of several small to medium sized laundry articles, for example washing loads from 0.01 kg or from 0.1 kg, to 5 kg, or to 10 kg, for example, for personal use to hold a gym kit or football kit. The inner volume of the bag is preferably from 0.0 m³ to 6 m³.

The bag may also comprise a transparent viewing patch, or part of the bag, or the whole bag, may be transparent, semi-transparent, semi opaque or any combination thereof. This enables the consumer to view what is contained in the bag. Preferably at least part of the first material and/or at least part of second material are transparent, semi-transparent, semi opaque, or any combination thereof

The bag may be colored with different colors, or comprise different markings or patterns on the surface. This could be used to indicate to the consumer the type of soiled laundry that is suitable to be contained in the laundry bag. The patterns are preferably made from dyes that are not fabric substantive; these dyes do not transfer to the soiled laundry during storage of the laundry in the bag, or during the washing process. The patterns may be embossed and/or printed onto the bag.

The bag may also contain a means of indicating to the consumer that the bag is full or the optimal amount, volume or weight of washing load is present in the bag. This could be in the form of markings on the bag indicating the optimal level the bag should be filled with wash load.

The bag typically has at least one opening. Typically, at least one opening of the bag gives access to the inner volume space of the bag. The opening can be closed, for example, by a closing means. The closing means is described in more detail hereinafter. The inner volume space of the bag can be separated into more than one compartment. These compartments are preferably separated by a barrier means. Preferably, the barrier means is made from the first material and/or the second material of the bag. Preferably, the barrier means is water-insoluble. Preferably, the barrier means is made of the first material of the bag. This allows the consumer to use different compartments to sort a washing load depending on consumer preference, for example by fabric type, fabric color, or soil/stain type or severity.

The bag can be designed such that; the bag, or part thereof, for example a single compartment of a multi-compartment bag, one or more dispensing units, or a combination thereof, will open, rupture, dissolve, disintegrate or a combination thereof, under specific conditions, for example temperature, pH, ionic strength or mechanical agitation. This provides a means of sequentially releasing a detergent composition or part thereof, if present, and/or laundry articles from the bag. In this preferred embodiment of the present invention the washing process is optimized. For example, a fabric softening agent is contained in a dispensing unit. The dispensing unit remains intact during the washing stages of a washing cycle, but disintegrates, dissolves or ruptures during the rinse stage of the washing cycle, thus releasing the fabric softening agent into the wash liquor. This could be in response to a specific condition, for example, mechanical agitation of the spin stage in an automatic washing machine, or the decrease in pH or ionic strength, of the wash solution due to the influx of water into the drum of an automatic washing machine during the rinse stage of the washing cycle. Therefore, in this manner, the softening agent is released from the dispensing device during the rinse stage of the washing cycle.

In another preferred embodiment of the present invention, a bleaching agent is preferably contained within a dispensing unit. The dispensing unit remains intact during the initial stages of a washing process, but dissolves, disintegrates and/or ruptures during a later stage in the washing process, and releases the bleaching agent into the wash liquor. Thus, providing a means of delaying the release of the bleaching agent into the wash liquor.

In another preferred embodiment of the present invention, a bleaching agent is preferably contained within a dispensing unit. The dispensing unit is made of material that is enzyme-degradable, for example a cellulosic or protein based material. Preferred enzyme-degradable material comprises polyvinyl alcohol. In this preferred embodiment of the present invention, the bag is typically used in combination with a detergent composition and an enzyme(s) capable of degrading the material of the dispensing unit. If the enzyme-degradable material comprises polyvinyl alcohol, then preferably the enzyme comprises polyvinyl alcohol dehydrogenase and/or polyvinyl alcohol oxidase. If either a polyvinyl alcohol dehydrogenase and/or polyvinyl alcohol oxidase is used, then preferably only the enzyme-degradable dispensing unit comprises polyvinyl alcohol, otherwise these enzymes may degrade other materials of the bag to the detriment of the present invention. Other preferred enzymes are esterases, lipases, proteases or combinations thereof. Release of the bleaching agent into the wash liquor is delayed until the enzyme(s) present in the wash liquor are active. Thus, in this preferred embodiment of the present invention, the enzyme activity in the wash liquor is improved. In this preferred embodiment, the enzyme(s) may be comprised by a detergent composition, or may be added to the wash liquor separately from the bag and/or the detergent composition, or may be contained within, or incorporated into, the laundry bag. If the enzyme(s) is incorporated and/or contained in the bag, then the enzyme(s) is typically contained and/or incorporated in the bag separately from the bleaching agent, if present.

First Material of the Laundry Bag

The first material of the laundry bag is substantially water-insoluble. The term “water-insoluble” is defined hereinbefore. The first material of the bag typically has a water-dispersibility of less than 50%, preferably less than 25%, or even less than 5%, as measured by the method set out hereinbefore, using a glass-filter with a maximum pore size of 50 microns. More preferably the first material typically has a water-solubility of less than 50%, preferably less than 25%, or even less than 5%, as measured by the method set out hereinbefore, using a glass-filter with a maximum pore size of 20 microns.

The first material of the bag preferably comprises a hydrophobic material, more preferably a material having similar properties to polypropylene. The first material may comprises polypropylene, polystyrene, polyamide such as nylon, or any combination thereof.

Preferably, the first material comprises: nylon; starch; polyethylene; polypropylene; polystyrene; polyvinyl chloride; polyesters; polyacrylonitrile; polyethylene terephthalate; co-polymers thereof including ethylene-propylene co-polymer, ethylene-butene-1 copolymer, vinyl chloride-vinyl acetate co-polymer and vinyl chloride-acrylonitrile copolymer; derivatives thereof including modified polyethylene terephthalate and modified polyester polyester chains extended with diisocyanate; and combinations thereof including a combination of polyethylene, polyester, polyurethane and/or starch.

Preferred first materials have similar properties to materials known under the tradename as Linopore supplied by Linotec Development GmbH, Aschersleben, Germany.

Most preferably, the first material comprises polypropylene. Polypropylene has adequate structural strength, is light, and is readily available, making it ideal for use as the first material of the laundry bag.

The first material is preferably in the form of a film, a laminate of a film and a non-woven, or a combination thereof. Preferably, the first material is a laminate of a film and a non-woven material. If the first material is in the form of a laminate of a film and a non-woven material, then preferably when the bag is formed, the film side of the laminate is at least predominantly on the inside of the bag and the non-woven side of the laminate is at least predominantly on the outside of the bag. Consumers prefer the touch, and more easily handle, the non-woven side of a laminate. Consumers also prefer the aesthetic appearance of such a laminate. The first material may also be in the form of a laminate of a non-woven material and a film and a non-woven material. Preferably, the film is between the two layers of non-woven material. The two layers of non-woven material may be the same type of material or may be different. In this preferred embodiment of the present invention, a non-woven material is at least predominantly present on the outside of the bag, giving similar benefits to those described hereinbefore, and also a non-woven material is predominantly present on the inside of the bag, which allows other ingredients such as odor control agents, perfumes, dye transfer inhibitors, other ingredients of a detergent composition and any combination thereof to attach to the non-woven layer inside the bag. The laminate can be formed by any known bonding method, for example heat bonding or solvent bonding, preferably heat bonding.

The first material optionally comprises a component selected from the group consisting of odor control agent, perfume, dye transfer inhibition, and combinations thereof. The component may be incorporated into the first material of the bag, or may be sprayed onto the first material of the bag. This is a convenient method of containing the component in the bag. Typically, the component is incorporated in the first material of the bag during the formation of the first material of the bag. For example, if the first material is in the form of a film or laminate, then the component is added to the film or laminate during its formation, typically when the film or laminate is in a pliable or semi-pliable, or a molten or semi-molten state.

Typically, films and laminates are formed by either extrusion or moulding process(es) and are typically in a pliable or semi-pliable, or molten or semi-molten state, for example in the form of a hot melt, during at least part of the process for forming the film or laminate. The component is preferably added to the first material during the process of preparing the first material, when the first material is in the form of a hot melt, or added immediately after the first material is in the form of a hot melt. This is especially preferred when the first material comprises a hydrophobic material with similar properties to polypropylene, or comprises polypropylene. This is because it is difficult to bind the component or spray the component onto polypropylene and other similar hydrophobic materials. When the first material is in a pliable or semi-pliable, or molten, or semi-molten form, the component, or part thereof, binds to the liquid phase of the first material in a molten, or semi-molten state, and becomes incorporated in the first material.

If the component is sprayed onto the first material, preferably the first material absorbs the component. In addition, preferably the component is sprayed onto the inside of the bag. This minimizes, reduces or prevents the amount of contact between the component or part thereof, and the consumer.

If a combination of an odor control agent, and/or perfume dye and/or a transfer inhibitor is contained in the bag, it may be preferred that the different components of the combination are comprised by different areas of the first material, and are typically contained separated from each other in the bag. This is especially preferred if the different components are incompatible with each other, which could be preferred for an odor control agent and a perfume.

The first material may comprise a detergent composition or part thereof, if present. The first material may comprise a surfactant, a starch, a modified starch, or a combination thereof. It may be preferred that only part of the first material comprises a surfactant, a starch, a modified starch, or a combination thereof.

Second Material of the Laundry Bag

The second material of the laundry bag is water-soluble and/or water dispersible. The second material of the bag preferably forms at least one seal, preferably at least two seals, or preferably at least three seals of the laundry bag.

The second material can be in the form of a thread, and is typically sewn into the first material to form at least one seal, which is in the form of a seam. The thread typically has a diameter of from 10 to 1000 micrometers, preferably from 100 to 300 micrometers.

The second material can also be in the form of a glue or adhesive, and can be used to form a seal by any known sealing method including heat sealing, pressure sealing, solvent sealing, ultrasonic sealing, or a combination thereof.

Preferably, the second material comprises a component selected from the group consisting of: polyvinyl alcohols, copolymers thereof, ter-polymers thereof and combinations thereof; co-polymers of a styrene and acrylic acid; polyvinyl pyrrolidone; polyalkylene oxides; cellulose and/or modified cellulose such as cellulose-ethers and/or cellulose-esters and/or cellulose-amides and/or derivatives thereof, a preferred cellulose is hydroxypropyl methyl cellulose; polycarboxylic acids and salts thereof, including polyacrylates, copolymers of maleic/acrylic acids, copolymers of butylacrylic and acrylic acid; polyaminoacids, peptides, and combinations thereof; polyamides including polyacrylamide; polysaccharides including starch and/or gelatine; natural gums such as xanthum and/or carragum; derivatives thereof; and combinations thereof.

Preferably the second material comprises a polyvinyl alcohol polymer, a co-polymer thereof, a ter-polymer thereof or a combination thereof. Preferably, the polyvinyl alcohol has an average degree of hydrolysis of any range from 70%, or from 75%, or from 80%, or from 85%, or from 90%, or from 95%, and to 100%, or to 99%, or to 98%, or to 95%, or to 90%, or to 85%, or to 80%. Preferably, the polyvinyl alcohol has an average degree of hydrolysis of at least 80%, more preferably of from 80% to 90%, or preferably from 95% to 100%. Another highly preferred second material comprises a polymeric polycarboxylic material, preferably a polyacrylate. A preferred polyacrylate is known under the tradename “Belland” or “Fuller”. A highly preferred second material comprises polyvinyl pyrrolidone. A preferred pyrrolidone is sold known under the tradename “Luviskol”. Preferably, the second material comprises a plasticizer. Preferably, the plasticizer comprises a component selected from the group consisting of: glycol; glycerine; alcohol amine; alkoxylated phosphate; polyol; derivatives thereof; and combinations thereof. More preferably, the plasticizer comprises a component selected from the group consisting of: mono-ethylene glycol; di-ethylene glycol; tri-ethylene glycol; polyethylene glycol having a weight average molecular weight of from 155 to 400; glycerine; trimethylol propane; neopentyl glycol; triethanolamine; ethoxylated phosphates; and combinations thereof. Preferably, the plasticizer comprises more than one type of plasticizer, preferably at least two types of plasticizer. Preferably, the weight ratio of the first type of plasticizer to the second type of plasticizer is from 1:1 to 3:1, more preferably from 1.5:1 to 2.5:1. The second material preferably comprises (by weight of the second material) from 1%, or from 5%, or from 10%, or from 20%, or from 25%, and preferably to 60%, or to 50%, or to 40% plasticizer.

The second material preferably has a tensile strain of at least 1 kNm⁻¹, preferably greater than 3 kNm⁻¹, preferably greater than 5 kNm⁻¹, or greater than 7 kNm⁻¹. In one preferred embodiment of the present invention, the second material is in the form of glue that forms at least one seal on the laundry bag. Preferably the glue has a glue density of from 0.01 gm⁻¹ to 5 gm⁻¹, preferably from 0.05 gm⁻¹, or from 0.1 gm⁻¹ or from 0.2 gm⁻¹, and preferably to 4 gm⁻¹, or to 3 gm⁻¹ or to 2 gm⁻¹.

The second material may comprise a component selected from the group consisting of odor control agent, perfume, dye transfer inhibitor and combinations thereof. The component may be incorporated into the second material of the bag, or may be sprayed onto the second material of the bag. This is a convenient method of containing the component in the bag.

The second material may comprise a detergent composition or part thereof, if present. If present, the detergent composition or part thereof, is typically released into the wash liquor either during or subsequent to the second material dissolving.

The second material typically dissolves in the wash liquor and releases the soiled articles contained within the bag, into the wash liquor. If the second material comprises a detergent composition or part thereof, then the release of soiled articles and detergent composition/ingredients, into the wash liquor is optimized.

It may also be preferred to have different parts of the second material having different water-solubility properties. Hence, different parts of the second material will typically dissolve at different stages of the washing process. In this preferred embodiment of the present invention, the sequential release of detergent composition or part thereof, or soiled articles contained in the bag, into the wash liquor can be achieved. Thus, the washing process is optimized. For example, if the bag is a multi-compartment bag, wherein the different compartments are separated by a barrier means which is made from the second material and/or is sealed by the second material, then the different barriers for the different compartments, and/or the different seams for the different barriers, can be made of different types, or parts, of the second material which has different water solubility properties. The difference in water solubility of the different types or parts of the second material can be such that the contents of the different compartments of the multi-compartment bag are released into the wash liquor at different stages. Thus, optimizing the washing process.

The preferred second material has similar properties to the materials known under the tradename as Wash-A-Way supplied by YLI Corporation of Rock Hill, S.C., and/or BellStxTM (KBC 4120 HA) supplied by Belland A G, Biberist, Switzerland. Other preferred second materials are known under the tradenames “Bellstx KBC 4120 HA” and “Bellstx 4067” supplied by Belland A G, Biberist, Switzerland. A preferred second material is known under the tradename as “Luviskol K17 Powder”, supplied by BASF A G, Ludwigshafen, Germany. Another preferred second material comprises acrylic copolymer and is known under the tradename as Product Number PN-3496F, supplied by H. B. Fuller Company of Blue Ash, Ohio. Another preferred second material is known under the tradename as “Cycloflex” supplied by National Starch & Chemical SA, Villefranche, France. A preferred second material is known under the tradename as Product Number H9547 supplied by ATO Findley Inc. of Wauwatosa, Wis.

Closing Means

The inner volume space of the bag is typically closed, such that the inner volume space is separated from the outside by a tuck, tie, flap, fold, zip, button, drawstring or a combination thereof. The closing means is preferably non-permanent and the bag can be closed and re-opened numerous times. Alternatively, the closing means can be permanent, so that the bag can only be closed once. Upon closing the bag, any further contact between the laundry items contained therein and the consumer is prevented, reduced or minimized.

The closing means can be water-soluble, this is beneficial if only one water-soluble seal is present on the bag, since in this preferred embodiment of the present invention, the closing means will dissolve in addition to the water-soluble seam, when the bag is contacted to the wash liquor, thus increasing the rate of release of soiled garments from the bag. The closing means can be made from the second material.

In an alternative preferred embodiment of the present invention, the closing means can be made from water-insoluble material, for example the closing means can be made from the first material of the bag, or may comprise polypropylene and/or polyamide such as nylon.

The closing means is preferably hydrophilic. The closing means may have an additional function to closing the opening of the bag. The closing means may have dye transfer inhibition properties. This is especially preferred if the closing means comprises nylon.

Preferred closing means is made from nylon or cotton, and is preferably in the form of a drawstring. If the closing means is in the form of a drawstring, preferably the drawstring has a diameter of from 1.5 mm to 10 mm. Preferred closing means are drawstrings that are supplied by Lehigh.

Dispensing Unit

Preferably, the bag comprises a dispensing unit, which contains or comprises a component selected from the group consisting of odor control agent, perfume, dye transfer inhibitor and combinations thereof. Preferably, the component is contained in a dispensing unit which is sealed such that the component is separated from the rest of the inner volume space of the bag which is intended to contain soiled laundry.

A preferred dispensing unit is a cell, pouch, pocket, fold, packet, sheet or combination thereof. The dispensing unit is preferably made of a water-insoluble material. Preferably, the dispensing unit as a whole is water-insoluble. The dispensing unit may be an integral component of the laundry bag. This is especially preferred if the dispensing unit comprises one or more of the materials which the bag is made from, for example the first material of the bag and/or the second material of the bag. Alternatively, the dispensing unit may not be an integral component of the bag, although even if the dispensing unit is not an integral component of the bag, the dispensing unit may still be made the same type of material or materials from which the bag is made from.

The inventors have found that the flexibility of the bag is further improved when a detergent component is contained in a dispensing unit, which is not an integral component of the bag. If the dispensing unit is not an integral component of the bag, the consumer can remove, replace, exchange or add numerous detergent components selected from odor control, perfume, dye transfer inhibitor or combinations thereof, to or from the bag. This allows the consumer to modify the laundry bag according to their own preference, for example depending on their likes and dislikes, and on the amount or severity of soiled laundry to be deposited in the bag.

The dispensing unit can be designed such that when the bag is closed, or in response to some other action directed on or toward the bag, the dispensing unit is ruptured or burst so that the component, detergent composition or part thereof, and/or other ingredients contained within the dispensing unit, is released from the dispensing unit. Also, it may be preferred that more than one dispensing units containing or comprising different components or ingredients, are contained in the bag. The preferred number of dispensing units contained in the bag is determined by the size of the wash load to be washed and the severity of the soiling of the wash load. Typically, from one to five dispensing units can be contained in the bag. Different dispensing units may contain different fabric treatment agents, for example fabric treatment agents that are incompatible with each other. Therefore, the use of more than one dispensing unit in the bag provides a means of separating incompatible components and/or ingredients from each other.

A Detergent Component Selected from the Group Consisting of Odor Control Agent, Perfume, Dye Transfer Inhibitor and Combinations thereof

The bag comprises a detergent component selected from the group consisting of odor control agent, perfume, dye transfer inhibitor and combinations thereof, which is herein referred to as “component”. The component may be in the form of a solid (such as a granular composition, for example, tablet or powder), a liquid, a paste, a gel, or a combination thereof.

The component may be comprised by, and/or incorporated in, the first material and/or second material of the bag. The component may be sprayed onto, and may be absorbed by, the first material and/or second material of the bag. Preferably, the component is contained in the bag such that the component is separated from the inner volume space, which is intended to contain soiled laundry, which is deposited therein.

The component may be contained in a dispensing unit; the dispensing unit is described in more detail hereinbefore. The bag in the form of a sheet may contain the component.

If the component is a comprises an odor controlling agent and a perfume, then it may be preferred that the component comprises low amounts of perfume such as from 0.1% by weight or from 0.2% by weight perfume (based on the total weight of the component). Alternatively, if the component does not comprise an odor controlling agent, then it may be preferred that the component comprises high amounts of perfume such as from 40% by weight or from 80% by weight perfume (based on the total weight of the component). The odor controlling agent and the perfume are described in more detail hereinafter.

Odor Controlling Agent

When soiled laundry is added to the laundry bag, an odor can develop which gives a negative impression to the consumer and prevents or dissuades the consumer from leaving soiled laundry in the bag for the length of time required to fill the bag to the optimal level. In such circumstances, the consumer does not wait for the bag to be full and instead uses a half full laundry bag during the washing process. This results in an inefficient consumption of laundry bags.

The inventors have found that this inefficient consumption can be overcome by providing a bag that contains an odor controlling agent. The odor controlling agent preferably comprises an ingredient selected from the group consisting of cyclodextrin, ultra wide pore zeolite or derivative thereof, metallic odor control salts, anti-microbial agent, activated carbon, potassium permanganate, and combinations thereof.

Preferably, the cyclodextrin may comprise an unsubstituted cyclodextrin comprising from six to twelve glucose units. The term “unsubstituted” means that the cavities within the cyclodextrin are substantially empty, preferably completely empty, in order to allow the cyclodextrin to absorb various odor molecules from soiled laundry that is deposited in the bag.

Preferably, the cyclodextrin has a primary particle size of less than 12 micrometers, preferably less than 10 micrometers, preferably less than 5 micrometers. This primary particle size refers to the largest dimension of the cyclodextrin primary particle. Cyclodextrins having this small primary particle size have a higher surface area per weight of cyclodextrin and, thus, have a greater capacity of absorbing odor. Preferred cyclodextrins are alpha-cyclodextrin and derivatives thereof, gamma-cyclodextrin and derivatives thereof, beta-cyclodextrin derivatives, and combinations thereof. Suitable cyclodextrin derivatives for use herein include hydroxypropyl alpha-cyclodextrin, methylated alpha-cyclodextrin, methylated beta-cyclodextrin, hydroxyethyl beta-cyclodextrin and hydroxypropyl beta-cyclodextrin. Cyclodextrins and derivatives thereof suitable for use herein are described in U.S. Pat. Nos. 3,426,011, 3,453,257, 3,453,258, 3,453,259, 3,453,260, 3,459,731, 3,553,191, 3,565,887, 4,535,152, 4,616,008, 4,678,598, 4,638,058 and 4,746,734. Preferred cyclodextrins for use herein are described in more detail in U.S. Pat. No. 5,429,628.

The odor controlling agent may comprise ultra wide pore zeolite or derivative thereof. Zeolites A, X and Y, which are known building agents in detergent compositions, and Zeolite ZSM-5 which has a similar pore size to Zeolites A, X and Y, are not within the meaning of the term “ultra wide pore zeolites” for the purpose of the present invention. Although it may be preferred that the bag contains or comprises zeolite A, X, Y, ZSM-5 or a combination thereof. If zeolite A, X, Y or a combination thereof is present in the bag, then it may be preferred that the bag further contains or comprises an odor controlling agent, for example an ultra wide pore zeolite or derivative thereof.

Ultra wide pore zeolites or derivatives thereof preferably have a pore diameter of at least 13 angstroms, more preferably at least 20 angstroms, even more preferably at least 30 angstroms, or even 50 angstroms, most preferably from 30 to 100 angstroms. The pore diameter can be determined by any suitable method, for example by transmission electron microscopy (TEM), x-ray diffraction or argon physisorption. TEM is the preferred technique. These ultra wide pore zeolites or derivatives thereof, preferably have a surface area of at least 300 m² g−¹, more preferably at least 400 m² g−¹, most preferably at least 500 m² g−¹.

Suitable ultra wide pore zeolite derivatives are ultra wide pore zeolite alumino-derivatives. Preferred ultra wide pore zeolite alumino-derivatives are aluminophosphates, silicoaluminophosphates, metalloaluminophosphates and metallosilicoaluminophosphates, wherein ‘metallo’ represents an additional metallic element such as Mg, Ti, Mn, Co, Fe, Ga or Zn.

Other suitable ultra wide pore zeolite derivatives are ultra wide pore zeolite phosphate-derivatives. Preferred ultra wide pore zeolite phosphate-derivatives are AIPO4-5, AIPO4-8, SAPO-5, SAPO-37, VPI-5, Cloverite (an 18-componented ring gallophosphate), and JDF-20.

Other preferred ultra wide pore zeolite derivatives are the liquid crystal template-synthesised M41S range of compounds described in U.S. Pat. No. 5,102,643, 5,250,282, 5,264,203, 5,145,816, 5,098,684, 5,378,440, 5,098,684, 5,108,725 and 5,057,296. These M41S range of compounds exhibit, after calcination, an x-ray diffraction pattern with at least one peak at a d-spacing greater than 18 angstroms with a relative intensity of 100 and a benzene adsorption capacity of greater than 15 grams benzene per 100 grams of anhydrous crystal at 50 torr and 25° C.

Highly preferred M41S compounds are inorganic, porous, crystalline material having, after calcination, a hexagonal arrangement of uniformly-sized pores having a pore diameter of at least 13 angstroms and exhibiting a hexagonal electron diffraction pattern that can be indexed with a d100 value greater than 18 angstroms. Such materials have been given the designation MCM-41 and are described in more detail in U.S. Pat. No. 5,378,440.

The odor controlling agent may comprise a metallic odor control salt. The metallic odor-control salts preferably comprise zinc salt, copper salt or mixtures thereof. The metallic odor control salt preferably comprises a component selected from the group consisting of zinc chloride, zinc gluconate, zinc lactate, zinc maleate, zinc salicylate, zinc sulfate, copper chloride, copper gluconate and combinations thereof. The metallic odor controlling salt, especially zinc salts, may be an anti-microbial agent. Zinc salts which are metallic odor controlling salts that have anti-microbial properties, are described hereinafter.

The odor controlling agent may comprise an anti-microbial agent. The anti-microbial agent has anti-microbial properties such as anti-bacterial properties, anti-fungal properties or combinations thereof. Other anti-microbial agents that do not act as odor controlling agents may be present in the bag. These anti-microbial agents may be present in the bag for hygiene reasons and not for odor control. However, if these anti-microbial agents, which are not odor controlling agents, are present, then it is preferred that other anti-microbial agents that do act to control odor are also present in the bag.

Preferred anti-microbial agents suitable for use as odor controlling agents are selected from the group consisting of zinc phenolsulfonate, zinc oxide, triclosan, zinc ricinoleate, zinc undecylenate, and combinations hereof. A preferred anti-microbial compound for use herein is known under the trade name as Zelec AM supplied by Du Pont, and Irgasan DP-300 supplied by Ciba Geigy. Other anti-microbial agents suitable for use herein are described in more detail on page 10 of the 1994 edition of the “Cosmetic Bench Reference”.

The odor control agent may be applied to the bag in combination with a grafting agent. Preferred grafting agents are the same as the preferred grafting agents for use with the dye transfer inhibitor, these grafting agents are described in more detail below.

Perfume

The bag preferably contains a perfume. If present the perfume is sprayed onto the first and/or second material of the bag. Preferably, the perfume is contained in the bag near to the opening of the bag. For example, the perfume may be sprayed onto the first material of the bag, typically near to the opening of the bag. The perfume may also be incorporated or contained on the closing means of the bag, if present. For example, the perfume may be sprayed onto the closing means. This is especially preferred if the closing means is in the form of a drawstring. If the perfume is near the opening of the bag, then the malodor due to the soiled articles contained in the bag is more readily masked and is less likely to be detected by the consumer when the consumer opens the bag to place more soiled articles in the bag.

The perfume may also be contained in a dispensing unit. The perfume may be released from the dispensing unit during the storage of the clothes in the bag. In this preferred embodiment of the present invention, the dispensing unit that contains the perfume is preferably gas-permeable. For example, the dispensing unit may be made of material which comprises pores that have a mean pore size which is larger than the mean pore size of the compounds released by the perfume into the bag, thus allowing movement of the perfume compounds through the pores in the material of the dispensing and into the internal volume of the bag which contains the soiled laundry.

If the bag also contains an odor control agent, then it is highly preferred to contain the perfume and the odor control agent separate from each other in the bag. This is to prevent the odor controlling agent and the perfume complexing together and cancelling the functional properties of each other out. This is especially preferred if the odor control agent is a cyclodextrin and/or a wide pore zeolite.

Preferred perfumes contain at least one component with a low molecular weight volatile component, typically having a molecular weight of from 150 to 450 or preferably 350. Preferably, the perfume comprises an oxygen-containing functional group. Preferred functional groups are aldehyde, ketone, alcohol or ether functional groups or mixtures thereof.

Preferred aldehydes are selected from citral, 1-decanal, benzaldehyde, florhydral, 2,4-dimethyl-3-cyclohexen-1-carboxaldehyde; cis/trans-3,7-dimethyl-2,6-octadien-1-al; heliotropin; 2,4,6-trimethyl-3-cyclohexene-1-carboxaldehyde; 2,6-nonadienal; alpha-n-amyl cinnamic aldehyde, alpha-n-hexyl cinnamic aldehyde, P.T. Bucinal, lyral, cymal, methyl nonyl acetaldehyde, trans-2-nonenal, lilial, trans-2-nonenal, lauric aldehyde, undecylenic aldehyde, mefloral and combinations thereof thereof.

Preferably, the perfume ketone is selected from buccoxime; iso jasmone; methyl beta naphthyl ketone; musk indanone; tonalid/musk plus; Alpha-Damascone, Beta-Damascone, Delta-Damascone, Iso-Damascone, Damascenone, Damarose, Methyl-Dihydrojasmonate, Menthone, Carvone, Camphor, Fenchone, Alpha-Ionone, Beta-Ionone, Gamma-Methyl so-called Ionone, Fleuramone, Dihydrojasmone, Cis-Jasmone, Iso-E-Super, Methyl-Cedrenyl-ketone or Methyl-Cedrylone, Acetophenone, Methyl-Acetophenone, Para-Methoxy-Acetophenone, Methyl-Beta-Naphtyl-Ketone, Benzyl-Acetone, Benzophenone, Para-Hydroxy-Phenyl-Butanone, Celery Ketone or Livescone, 6-Isopropyldecahydro-2-naphtone, Dimethyl-Octenone, Freskomenthe, 4-(1-Ethoxyvinyl)-3,3,5,5,-tetramethyl-Cyclohexanone, Methyl-Heptenone, 2-(2-(4-Methyl-3-cyclohexen-1-yl)propyl)-cyclopentanone, 1-(p-Menthen-6(2)-yl)-1-propanone, 4-(4-Hydroxy-3-methoxyphenyl)-2-butanone, 2-Acetyl-3,3-Dimethyl-Norbornane, 6,7-Dihydro-1,1,2,3,3-Pentamethyl-4(5H)-Indanone, 4-Damascol, Dulcinyl or Cassione, Gelsone, Hexalon, Isocyclemone E, Methyl Cyclocitrone, Methyl-Lavender-Ketone, Orivon, Para-tertiary -Butyl-Cyclohexanone, Verdone, Delphone, Muscone, Neobutenone, Plicatone, Veloutone, 2,4,4,7-Tetramethyl-oct-6-en-3-one, Tetrameran, hedione, and combinations thereof. More preferably, the preferred ketones are selected from Alpha Damascone, Delta Damascone, Iso Damascone, Carvone, Gamma-Methyl-Ionone, Iso-E-Super, 2,4,4,7-Tetramethyl-oct-6-en-3-one, Benzyl Acetone, Beta Damascone, Damascenone, methyl dihydrojasmonate, methyl cedrylone, hedione, and combinations thereof.

Preferred are also perfume compositions comprising perfume oils and a carrier material, for example as described in: JP-56075159, describing the combination of methacrylonitrilebutadiene-styrene tertiary polymer with a liquid perfume; GB2141726, DE 3247709; WO 97/34982; WO 94/19449; and WO 98/28398. Preferably, the carrier is a water-insoluble polymer, preferably selected from polymers that have chemically reacted with the perfume ingredient, to make the carrier as above mentioned.

Preferably, the perfume is in the form of oil. The perfume is preferably mixed with alcohol, and sprayed onto the inside and/or outside of the bag. Preferably the perfume/alcohol mixture comprises from 0.01% to 99% perfume, preferably from 0.1% to 50%, or 0.2% to 10%, or 0.3% to 1% perfume. The remaining part of the mixture is made up of the alcohol, preferably exclusively made up of the alcohol. Preferred alcohols comprise methanol, ethanol, propanol, iso-propanol, diols such as propandiol, or any combination thereof.

Dye Transfer Inhibitor

The bag preferably contains a dye transfer inhibitor. The dye transfer inhibitor may be contained on, or incorporated therein to, the first material and/or second material of the bag. The dye transfer inhibitor may also be contained on, or incorporated therein to, the closing means of the bag, if present. This is especially preferred if the closing means is in the form of a drawstring.

The dye transfer inhibitor can act to prevent dye transfer between colored fabrics contained within the bag prior to, or during, or subsequent to the aqueous washing stage of the laundering process. Preferably the dye transfer inhibition agents are released into the wash liquor during the washing process. The dye transfer inhibition agents may also be released into the inner volume of which contains the soiled articles.

Preferred dye transfer inhibitors comprise polyamine N-oxide polymers, copolymers of N-vinylpyrrolidone and N-vinylimidazole, polyvinylpyrrolidonepolymers or any combination thereof. Preferred dye transfer inhibitors comprise co-polymers of N-vinylpyrrolidone and N-vinylimidazole, polyvinylpyrrolidone, polyvinylpyridine-N-oxide, and any combination thereof. Most preferred polyvinyl pyrrolidone derivatives are: copolymers of polyvinylpyrrolidone and vinyl imidazole such as copolymers sold under the trade name Sokolan HP 56; copolymers of vinyl pyrrolidone and sodium methacrylate such as copolymers sold under the trade name Sokolan VPMA by BASF A G, Germany; copolymers of vinyl pyrrolidone and alkylamino substituted methacrylate, styrene or acrylic acid, vinyl caprolactam and/or vinyl acetate.

The dye transfer inhibitor may be incorporated in the bag by any chemical, thermal, and ultraviolet grafting technique. For example, the dye transfer inhibitor may be applied to the bag in combination with a grafting agent. The grafting agent typically has a higher affinity for the first material and/or second material than the dye transfer inhibitor. In one preferred embodiment of the present invention, the grafting agent has additional dye absorbing properties. In one preferred embodiment of the present invention, the grafting agent and/or the dye transfer inhibitor remains immobilized on the material of the bag, preferably the first material, during the washing process. In one preferred embodiment of the present invention, the dye transfer inhibitor is applied to the bag prior to the grafting agent being applied to the bag.

Suitable grafting agents are selected from the group consisting of polyamidoamine-polyamine epichlorohydrin resins and/or polyvinyl pyrrolidone and derivatives thereof. Most preferred grafting agents are polyamidoamine-polyamine epichlorohydrin resins such as resins sold under the trade names Kymene® 557H, Kymene® 557LX, Kymene® 450, Kymene® 2064 (Hercules, Inc. Wilmington, Del.), and Luresin® KNU by BASF A G, Germany. A preferred grafting agent comprises a polyamidoamine-polyamine epichlorohydrin resin and copolymers of polyvinylpyrrolidone and vinyl imidazole. Preferably, the weight ratio of dye transfer inhibitor to grafting agent is from 10:1 to 1:10, preferably from 2:1 to 1:2. Preferably, the dye transfer inhibitor is applied to the bag in the form of a solution having a concentration of from 10 w/v % to 90 w/v %, preferably from 15 w/v % to 30 w/v %.

Detergent Composition or Part thereof

Furthermore, in one preferred embodiment of the present invention, the laundry bag contains a detergent composition or part thereof. If the laundry bag contains a detergent composition, there is no need for the consumer to re-open the bag to add thereto a detergent composition. If the detergent composition is contained within the bag, there is also no need for additional detergent composition to be added to the washing load during the washing process. The bag provides a convenient means of washing fabric, especially during conventional washing practices such as, for example, using an automatic washing machine.

The bag may also be used in combination with a detergent composition or part thereof. The detergent composition is preferably not contained within the bag. The detergent composition or part thereof, and the laundry bag may be added separately to the wash liquor. The detergent composition or part thereof may be added to the bag, preferably immediately prior to adding the laundry bag to the wash liquor. This allows the detergent ingredients to interact with the soiled articles contained within the bag quickly and improves the washing process.

Preferably, the detergent composition comprises a bleaching agent and/or a fabric softening agent. The detergent composition may also comprise other conventional detergent ingredients such as surfactant, builder, chelant, suds suppressor, and any combination thereof. Preferably the bag does not contain any enzymes. Although, enzymes can be added to the wash liquor and used ion combination with the laundry bag.

Bleaching Agent

The detergent composition may comprise a bleaching agent. Preferably the bleaching agent comprises perhydrate bleach, such as salts of percarbonates, particularly the sodium salts. It has been found that when the material of the bag comprises free hydroxy groups, such as Polyvinyl alcohol, the preferred bleaching agent comprises a percarbonate salt and is preferably free form any perborate salts and borate salts. The borates and perborates interact with hydroxy-containing materials, and can reduce the rate of dissolution of these materials and may also result in reduced performance. Thus, the detergent composition for use herein is preferably free of borate ions.

Preferred bleaching agents may comprise organic peroxyacid bleach precursor or activator compound, such as alkyl percarboxylic precursor compounds of the imide type include the N-,N,N¹N¹ tetra acetylated alkylene diamines wherein the alkylene group contains from 1 to 6 carbon atoms, particularly those compounds in which the alkylene group contains 1, 2 and 6 carbon atoms such as tetraacetyl ethylene diamine (TAED), sodium 3,5,5-tri-methyl hexanoyloxybenzene sulfonate (iso-NOBS), sodium nonanoyloxybenzene sulfonate (NOBS), sodium acetoxybenzene sulfonate (ABS) and pentaacetyl glucose, but also amide substituted alkyl peroxyacid precursor compounds.

Fabric Softening Agent

The detergent composition or bag may comprise or contain a fabric softening agent. The fabric softening agent may be contained on, or incorporated therein, to the first material and/or second material of the bag. Preferably the fabric softening agent is contained within a dispensing unit. Preferably the release of the fabric softening agent from the dispensing unit into the wash liquor is delayed, preferably delayed until the rinsing stage of the washing process, by any means described herein.

Preferred fabric softening agents comprise clay minerals that provide fabric softening properties. These clay minerals are usually smectite clays. Smectite clays suitable for use herein are described in: U.S. Pat. Nos. 3,862,058, 3,948,790, 3,954,632 and 4,062,647. Such clays include, for example, montmorillonite, volchonskoite, nontronite, hectorite, saponite, sauconite, and vermiculite.

Other suitable softening agents are long chained polymers and copolymers derived from such monomers as ethylene oxide, acrylamide, acrylic acid, dimethylamino ethyl methacrylate, vinyl alcohol, vinyl pyrrolidone and ethylene imide. Preferred are polymers of ethylene oxide, acrylamide and acrylic acid.

Other suitable softening ingredients include cationic fabric softening agents. Suitable cationic fabric softening agents include the water insoluble tertiary amines or dilong chain amide materials as disclosed in GB-A-1 514 276 and EP-B-0 011 340.

Process for Making the Laundry Bag

The bag can be made by any process that converts a water-insoluble material and a water-soluble material, typically in the form of a film or a laminate of a film and a non-woven material, into a structure suitable for use as a laundry bag. The material can be shaped by any method known in the art, for example by cutting with a knife.

The bag can be made from one or more pieces of water-insoluble material, and one or more pieces of water-soluble material. Preferably, the first material is shaped into a bag like structure, by sealing at least one piece of the first material together, preferably using the second material of the bag. For example, by heat sealing, pressure sealing, solvent sealing, ultrasonic sealing, gluing, sewing means, or any combination thereof. Preferably the seals are formed using a temperature of from 50° C. to 200° C., preferably from 120° C. to 175° C., which is applied to the material of the bag to be sealed or which is forming the seal, for from 0.1 to 10 seconds.

If the bag is formed by gluing pieces of material together, then preferred glue for use herein is water-soluble glue, more preferred is that the second material of the bag is in the form of glue. Preferably, if used, the glue comprises a polyvinyl alcohol polymer, a co-polymer thereof, a ter-polymer thereof, a derivative thereof or a combination thereof. Preferably, at least one or more than piece of the first material of the bag is sewn together. Typically this is done using the second material of the bag, which is preferably in the form of a thread.

The first material is preferably sewn together by the second material, which is in the form of a thread, to form the walls of the bag. This can be done on a sewing machine suitable for use in the home, such a sewing machine known under the tradename as “Stretch and Jeans 6120”. These home use sewing machines are typically used at an rpm of from 10 to 500 rpm. Other sewing machines that can be used are industrial sewing machines, such as those known under the tradename as MO-3904B-0D6-300/SC-380/Z185 supplied by JUKI Union Special Inc. these industrial sewing machines can be used at an rpm of from 3000 to 9000.

Preferably the second material is sewn into the first material at a stitch density of at least 2 stitches per centimeter, preferably from 3 stitches per cm to 6 stitches per centimeter.

If the sides of the bag are sewn together, preferably a single straight line seam is used. However, multiple line seams, such as two or three lines, can be used. It may be preferred to use a double stitch pattern for areas of the bag that require more robust and stronger seams, such as at the top of the bag.

If glue is used to form the sides of the bag, preferably the glue is melted and then applied to part of the bag material, such as the first material, in such a manner so that the glue forms a seam.

Typically, the process of sealing the bag results in the formation of at least one seal, preferably at least two seals and even at least three seals. The seals can be present on the rear face of the bag, the side of the bag, the front face of the bag , the bottom of the bag, the top of the bag, or any combination thereof.

Preferably the seals are present on opposite sides of the bag, or are present on one side of the bag and the bottom of the bag. If damp soiled articles are placed in the bag, then there is a tendency for the water contained in the soiled articles to collect at the bottom of the bag during storage. This is especially true if the bag is stored in an upright position. For this reason, it is preferred that the bottom of the bag does not contain a seal. If the bottom of the bag does contain a seal, then preferably the seal is protected by an overlap or strip of water-insoluble material, preferably the first material of the bag. Seals present on the side of the bag may also be protected by an overlap or strip of water-insoluble material if desired. This preferred embodiment of the present invention may be suitable for use for applications where wet articles such as swim wear is placed in the bag. The water-insoluble overlap or strip, if present, typically does not affect the release of articles from the bag, especially through the fissure that is typically formed in the bag during the washing process by the second material dissolving.

Method of Use

Soiled laundry is deposited in the bag, and the bag is preferably closed. The bag is then preferably placed in the drum of an automatic washing machine. A detergent composition may be either contained within the bag, or added to the bag, or is added to the wash liquor separately from the bag, for example via a dispensing draw of an automatic washing machine.

The automatic washing machine typically undergoes one washing cycle, during which the water-soluble material of the laundry bag, dissolves during the washing cycle, such that no residues are left on the laundry after the washing process, and in such a manner so that the soiled laundry to be washed is released into the wash liquor during the washing cycle.

After the washing cycle is completed, the washed laundry is removed from the automatic washing machine and allowed to dry by any laundry drying means known in the art, for example by using a tumble drier or a washing line. The remaining part of the bag that has not dissolved during the washing process is typically removed from the automatic washing machine. Preferably, this undissolved portion of the bag is in one piece. Alternatively, the bag can be used in a hand-wash process, or any other laundry washing process known in the art. Preferably, the bag is used in an automatic washing machine process.

### EXAMPLES

### Example 1

A 400 mm×800 mm rectangular piece of a laminate material comprising polypropylene, known under the tradename as Linopor, supplied by Linotec is used to make a laundry bag. The two short sides (400 mm) of the rectangle are folded over by 25 mm and heat sealed along their length using a Hulme Martin heat sealer to form two tubular holes on both sides of the rectangle. The rectangle is then folded in the middle across the 400 mm length to form a rectangle of 400 mm×350 mm. The material is folded so that the non-woven side of the laminate is on the outside and the film side of the laminate is on the inside. The two short sides (350 mm) are sewn together using a water-soluble polyvinyl alcohol thread known under the tradename Wash-A-Way® supplied by YLI Corporation, at a stitch density of 3.5 stitches per cm. A cotton string is threaded through the tubular structures made by the heat sealer to form a drawstring, which can open and close the bag.

### Example 2

A bag is made by the process of example 1 except that a polyvinyl alcohol glue known under the tradename as Cycloflex® supplied by National Starch is used instead of a thread to seal the sides of the bag. From 0.8 g to 1 g of glue is used per meter of seam length. The glue is applied to the laminate material and light pressure is used to seal the two sides of the rectangle together. The bag is left overnight for the seals to harden.

### Example 3

75 g of the following detergent compositions are placed in one corner of a bag obtained by the process described in examples 1 and 2, respectively. The detergent composition is sealed in place by making seals both to the top and the side around the detergent composition, to obtain a laundry bag.

| Ingredient | A | B | C | D | E | F | G | H |
|---|---|---|---|---|---|---|---|---|
| Alkoxylated | 1 | 1 | 5 | 2 | 3 | 0.08 | 8 | 1 |
| alcohol | | | | | | | | |
| Wide pore | 1 | 2 | 0.5 | 6 | 8 | 2 | 8 | 4 |
| zeolite MCM41 | | | | | | | | |
| C₁₂₋₁₅ alkyl | 1 | 0.5 | 0.8 | 1.2 | | | | |
| ethoxylate | | | | | | | | |
| sulphonate | | | | | | | | |
| Fatty acid | 2 | 0.5 | 0.2 | 1.5 | 0.2 | 0.8 | 1 | 0.6 |
| sulphonate | | | | | | | | |
| Linear alkyl | 5 | 6 | 6.5 | 5 | 7 | 5.5 | 6 | 5.5 |
| benzene | | | | | | | | |
| sulphonate | | | | | | | | |
| Carbonate | 16 | 15 | 20 | 18 | 25 | 27 | 15 | 22 |
| Silicate | 0.05 | 0.1 | 0.08 | 0.2 | 0.05 | 0.1 | 0.2 | 0.15 |
| Sulfate | 28 | 15 | 7 | 20 | 10 | 12 | 27 | 31 |
| Citric Acid | 2.5 | 2 | 4 | 1.5 | 5 | 3 | 3.5 | 4 |
| Crystalline | 2 | 4 | 3.5 | 5 | 2.5 | 3 | 4 | 4.5 |
| layered silicate | | | | | | | | |
| Zeolite A | 15 | 20 | 17.5 | 15 | 18 | 16 | 14 | 15 |
| Chelating agent | 0.1 | 0.5 | 0.05 | 0.15 | 0.25 | 0.2 | 0.1 | 0.15 |
| Sulfate | 0.5 | 0.4 | 0.3 | 0.3 | 0.4 | 0.2 | 0.5 | 0.25 |
| Percarbonate | 12 | 15 | 18 | 10 | 8 | 12 | | |
| Bleach activator | | | | | | | 2 | |
| Peracid | 2.5 | 2 | 1.5 | 3 | 1 | 5 | | |
| Photobleach | 0.00 | 0.00 | | | 0.00 | | | |
| | 1 | 5 | | | 2 | | | |
| Brightener | 0.02 | 0.1 | 0.08 | 0.05 | 0.1 | | | |
| Carboxymethyl | 0.15 | 0.1 | 0.2 | 0.5 | 0.05 | 0.1 | 0.25 | 0.1 |
| cellulose | | | | | | | | |
| Soil suspension | 1.5 | 2.5 | 2 | 2.5 | 1 | 3 | 0.5 | 1.0 |
| agent | | | | | | | | |
| Anti-redeposition | 0.15 | | 0.03 | 0.2 | 0.05 | | 0.4 | 0.01 |
| agent | | | | | | | | |
| Silicone | 0.05 | 0.1 | 0.02 | | 0.08 | 0.01 | 0.05 | 0.03 |
| antifoam | | | | | | | | |
| Enzymes | 1.0 | 0.8 | 0.6 | 1.2 | 0.5 | | | 0.4 |
| Soap | 0.6 | 0.5 | 0.1 | 0.05 | 0.3 | 0.4 | 0.5 | 0.5 |
| Perfume particle | 0.3 | 0.4 | 0.25 | 0.5 | 0.4 | 0.6 | 0.3 | 0.2 |
| Miscellaneous | to | to | to | to | to | to | to | to |
| | 100% | 100% | 100% | 100% | 100% | 100% | 100% | 100% |

### Example 4

75 g of solid detergent, the formulation of which are described in more detail in example 4, are sealed in a pouch made of a PVA material, K2 40 gsm supplied by Cast Film Technology. The pouch was made by cutting two pieces of PVA material, K2 40 gsm supplied by Cast Film Technology, to rectangles of dimensions 20 cm by 16 cm. One piece of PVA material was placed parallel on top of the other piece of PVA material and the pieces of PVA material are sealed together on three sides using a Martin Hulme Heat Sealer, to form a pouch. The detergent composition is placed inside the pouch; the pouch is then closed by heat sealing the unsealed side. The pouch is sealed onto the bottom of a bag made according to the process described in examples 1 and 2, respectively, to obtain a laundry bag in accordance with the present invention.

### Example 5

1 liter of aqueous Kymene H557 solution having a concentration of 12.63 w/v % supplied by Hercules Corp., is mixed with 1 kg beta-cyclodextrin for five minutes to form a slurry. 176.2 g perfume is added to the slurry to form a perfumed slurry. Using a spray gun, from 0.01 g to 25 g of the perfumed slurry is applied to the inside of a laundry bag obtained by the process of example 1 and 2, respectively. The bag is left to dry overnight to obtain a laundry bag in accordance with the present invention.

### Example 6

18.1 g aqueous Kymene 557H solution supplied by Hercules (12.63% active) is mixed with 27.4 g aqueous Sokalan HP56 solution supplied by BASF (30% active) to form a mixture. The mixture is then sprayed onto a bag obtained by the process of example 1 and 2, respectively, to obtain a laundry in accordance with the present invention.

What is claimed is:

1. A laundry bag made of at least two types of material said material comprising:
(i) a first material that is water-insoluble; and
(ii) a second material that is water-soluble and/or water-dispersible;
the laundry bag comprising a component selected from the group consisting of odor control agent, perfume, dye transfer inhibitor, and combinations thereof.

2. A laundry bag according to claim 1, wherein the first material is water-impermeable.

3. A laundry bag according to claim 1, wherein the second material comprises polyvinyl alcohol or derivatives thereof including co-polymers and/or ter-polymers thereof.

4. A laundry bag according to claim 1, wherein the first material comprises polypropylene and/or derivatives thereof.

5. A laundry bag according to claim 1, wherein the second material forms at least one seam of the laundry bag.

6. A laundry bag according to claim 5, wherein the second material forms at least two seams of the laundry bag and wherein the seams are on opposite sides of the laundry bag from each other.

7. A laundry bag according to claim 5, wherein the second material forms at least two seams of the laundry bag, at least one seam is on the bottom of the bag and at least one seam is on the side of the bag.

8. A laundry bag according to claim 1, wherein the laundry bag contains a detergent composition or part thereof.

9. A laundry bag according to claim 1, wherein the bag comprises: an odor control agent and/or a perfume; and a grafting agent, wherein the weight ratio of odor control agent and/or perfume to grafting agent is from 1:2 to 2:1.

10. A laundry bag according to claim 9, wherein the odor control agent and the perfume are comprised separately in the laundry bag.

11. A laundry bag according to claim 9, wherein the odor control agent comprises cyclodextrin and/or a wide-pore zeolite or derivative thereof.

12. A laundry bag according to claim 1, wherein the bag comprises an odor control agent and/or a perfume, and the odor control agent and/or perfume is at least partially enclosed, preferably completely enclosed, with a gas-permeable material.

13. A laundry bag according to claim 1, wherein a component selected from odor control agent, perfume, dye transfer inhibition and combinations thereof, is incorporated in the first material and/or the second material of the bag.

14. A laundry bag according to claim 1, wherein the first material is in the form of a film or a laminate of a film and a non-woven material.

15. A laundry bag according to claim 1, wherein the bag comprises a dye transfer inhibitor and a grafting agent, wherein the weight ratio of dye transfer inhibitor to grafting agent is from 1:2 to 2:1.

16. A process for preparing a laundry bag said process comprising the steps of:
a) providing a laundry bag made of at least two types of material said material comprising:
(i) a first material that is water-insoluble; and
(ii) a second material that is water-soluble and/or water-dispersible; the laundry bag comprising a component selected from the group consisting of odor control agent, perfume, dye transfer inhibitor, and combinations thereof;
whereby the walls of the laundry bag defined by the inner volume space, are provided by a first and/or second material and optionally additional materials.

17. A process for preparing a laundry bag according to claim 16, comprising the step of sewing the second material of the bag which is in the form of a thread, into the first material of the bag, to form at least one seam of the laundry bag.

18. A combination of a laundry bag according to claim 1, and a detergent composition or part thereof to treat fabric.
